(19) United States
(12) Patent Application Publication
(10) Pub. No.: US 2026/0218929 A1
(43) Pub. Date: Jul. 30, 2026

(54) Ducted Ventilation System, Particle Collection Unit and Method

(71) Applicants: Virus Free Air B.V., Schiedam (NL); E. KHOURY HOLDING B.V., Etten-Leur (NL)

(72) Inventors: Eliane Khoury, Schiedam (NL); Vincent Adrian Vons, Schiedam (NL); Louis-Pierre Geerinckx, Schiedam (NL)

(21) Appl. No.: 18/881,334

(22) PCT Filed: Jul. 7, 2023
(86) PCT No.: PCT/NL2023/050366

§ 371 Date: Jan. 6, 2025

(30) Foreign Application Priority Data
Jul. 7, 2022 (NL) 2032412

(51) Int. Cl. F24F 8/192; B03C 3/09; B03C 3/36; B03C 3/47; B03C 3/68; F24F 8/30

(52) U.S. Cl. CPC F24F 8/192; B03C 3/09; B03C 3/365; B03C 3/47; B03C 3/68; F24F 8/30

(57) ABSTRACT

A ducted ventilation system including a duct provided with a particle collection unit including an ionisation section and a particle collection section located downstream the ionisation section. The particle collection section is configured for removing particles from air flowing through the duct. The ionisation section includes one or more ionisation members and the particle collection section includes corresponding one or more particle collection members. Each ionisation member is attached to a corresponding particle collection member to form a slat element that is rotatable about a rotational axis between a first position wherein air flowing through the duct mainly flows through the slat elements and a second position wherein the air mainly flows along the slat elements.

### CROSS-REFERENCE TO RELATED APPLICATIONS

This application is the United States national phase of International Patent Application No. PCT/NL2023/050366, filed Jul. 7, 2023, and claims priority to The Netherlands Patent Application No. 2032412, filed Jul. 7, 2022, the disclosures of which are hereby incorporated by reference in their entireties.

### BACKGROUND OF THE INVENTION

### FIELD OF THE INVENTION

The subject disclosure relates to a ducted ventilation system. The invention further relates to a method for a ducted ventilation system.

### DESCRIPTION OF RELATED ART

Air ducts or air channels or air shafts are used for ventilation. These air ducts can be provided with many devices and systems for actuating air in the air ducts, heat exchangers, fans, valves and doors, filters, safety or rain gratings, and the like.

EP1434012A2 discloses air purifier with HEPA filter. An air purifier discharges air directly to a room without forcing the air to pass through a HEPA filter when the level of contaminations in the air, such as dust particles, is determined to be sufficiently low. The air purifier thus minimizes air pressure loss and attenuates operational noise caused by the HEPA filter. In an embodiment the HEPA filter is moved between a closed (in use) state and an open (bypassed) state.

Air duct systems for large constructions, like air ducts and ventilation shafts that are used for instance for parking garages, are dimensioned for the specific building to meet the desired specification with regard to ventilation capacity and safety.

For large air duct systems, the maximum volume flow rate is defined by regulations to suck sufficient air out of a space or to blow sufficient air into the space in case of extreme high concentration of pollutants or in case of fire, in order to remove smoke and increase visibility for occupants and emergency services. Furthermore, fire dampers and valves are installed in the ducts to prevent the fire in one space from spreading through the ventilation system to another space. These requirements in turn determine the minimum required capacity of the fan and the minimum dimensions of a duct. In order not to increase the costs too much, the capacity of a ventilator will be slightly above this minimum capacity and in order not to lose valuable indoor space the dimensions of the ducts will be slightly above the minimum dimensions.

To avoid malfunctions of the ducted ventilation systems, the fire dampers, valves and any other component located in a channel of the system require regular preventive maintenance. This requires them to be accessible to a service technician.

In order to reduce air pollution from extracted air from, for instance, parking garages, air filters are planned to be installed in existing air duct shafts of parking garages. The air filters have to reduce the particulate material, pollutants, NOx, fine particles and fine dust, generated by engines in a building, in the air blown out of the building. However, adding features in an air duct, especially filters, will increase the air resistance through the system and the power of the fan may no longer be sufficient to achieve the desired flow rate in maximum ventilation mode. The existing fan would then have to be replaced by a more powerful one, something which is very costly and, very often, not possible due to the increased size and electrical power consumption of a more powerful fan.

The term particulates-also known as atmospheric aerosol particles, atmospheric particulate matter, particulate matter (PM) or suspended particulate matter (SPM)-are microscopic particles of solid or liquid matter suspended in the air. The term aerosol commonly refers to the particulate/air mixture, as opposed to the particulate matter alone. Sources of particulate matter can be natural or anthropogenic. They have impacts on climate and precipitation that adversely affect human health, in ways additional to direct inhalation.

Types of atmospheric particles include suspended particulate matter; thoracic and respirable particles; inhalable coarse particles, designated PM10, which are coarse particles with a diameter of 10 micrometers (μm) or less; fine particles, designated PM 2.5, with a diameter of 2.5 μm or less; ultrafine particles, with a diameter of 100 nm or less; soot and Black Carbon.

The IARC and WHO designate airborne particulates as a Group 1 carcinogen. Particulates are the most harmful form of air pollution due to their ability to penetrate deep into the lungs, blood streams and brain, causing health problems including heart attacks, respiratory disease, and premature death.

In general, dust collection systems are used to control particulate concentration in the airflow internally and/or at the air outlet(s). These systems generally include inertial collectors (cyclonic separators); fabric filter collectors (baghouses), electrostatic filters used in facemasks, wet scrubbers, electrostatic precipitators, and combinations thereof.

Electrostatic filtering requires an ioniser where particles are charged and an electrostatic filter where charges particles are captured. The ioniser and electrostatic filter are, in flow direction separated from one another. The ioniser is usually upstream of the electrostatic filter. The electrostatic filter is consequently downstream of the ioniser.

Various components can often be hindering one another, in particular obstructing access to one another and/or creating high air resistance, obstruction to the airflow pattern and ventilation capacity. Especially in relatively large air ducts, adding functional elements, such as a particle filter, can be challenging.

### SUMMARY OF INVENTION

It is an object of the subject technology to provide a technology which enables to add a filtering function to existing air duct systems which overcomes at least one of the problems described above.

According to an aspect of the subject technology, this object is achieved by ducted ventilation system having the features as described herein. Advantageous embodiments and further ways of carrying out the present technology may be attained by the measures mentioned as described herein.

A ducted ventilation system according to the subject technology comprises a duct provided with a particle collection unit comprising an ionisation section and a particle collection section located downstream the ionisation section. The particle collection section is configured for removing particles from air flowing through the duct. The ionisation section comprises one or more ionisation members and the particle collection section comprises corresponding one or more particle collection members. Each ionisation member is attached to a corresponding particle collection member to form a slat element that is rotatable about a rotational axis between a first position wherein air flowing through the duct mainly flows through the one or more combinations of ionisation section and particle collection member and a second position wherein the air mainly flows along the one or more combinations of ionisation member and particle collection member.

An ionisation section can significantly improve particle capture. The ionisation section charges the particles in the air flow and thus increases the particle capture performance of an actively charged electrostatic filter element, an electret filter element or an electrostatic precipitator element using charged conductive plates or sheets of any form, for instance flat plates, honeycomb, bent or wavy sheets. At the same time, the use of an ionisation section allows the pressure drop over the particle collection section to be reduced. The improved particle capture by ionisation allows the performance of lower cost lower grade filters with lower pressure drop to be improved while the particle capture performance remains the same or even increases compared to a system without an ionisation section but with a particle collection section with higher grade filters that have a higher pressure drop.

Large ducted ventilation systems, such as exhaust ventilation system of a parking garage, require regular inspection of the ducts and components installed in the ducts. Successful filtration of the air in the duct requires one to pass all the air through the particle collection unit. A particle collection unit with or without ionisation section would therefore block the entire duct and would block access to any systems (for instance the fire dampers) located behind the particle collection unit. Other systems like fire dampers themselves can also form an obstruction; locating the particle collection unit behind systems like the fire damper would in turn greatly complicate installation and maintenance of the particle collection unit. Furthermore, to reduce contamination of the ventilation system, it is desirable to remove airborne particles from the airflow as quickly as possible, preventing them from contaminating the components and surfaces inside the duct, e.g. the fire dampers. Therefore, it is preferred to position a particle collection unit upstream the fire dampers and optionally directly behind a safety grille if such a grille is present. By making the entire particle collection unit rotatable, it allows access to the space and components located behind the filter.

If an ionisation section is present as in the system of this invention, this ionisation section also forms an obstruction to regular inspection of the ducts and components installed in the ducts. Therefore, the ionisation section also needs to be moved out of the way to allow access. However, in existing ventilation systems, mainly those with fire dampers, there is usually relatively little space available in installation or service area of the ducted ventilation systems and/or space between the dampers and the grille. Any excess space inside the ventilation system above the minimum which is required for properly allowing the air to flow, is space which does not contribute to the functionality of the building and is therefore considered a waste of valuable indoor space. Hence excess space inside these ducts is generally limited as much as possible during design and construction of the building. By attaching the ionisation section to the particle collection section, less space is required to rotate both of them and provide access to the space on the other side of the particle collection unit comprising an ionization section and particle collection section. The reduced overall size of the system thus obtained by combining the ionisation section and particle collection section in a single rotating member also makes that the particle collection unit can be installed in many more different structures, such as buildings and industrial facilities. Furthermore, due to this feature, the ionization section is located at a greater distance from the rotational shaft and the frame that holds the rotational axis in place. This reduces the likelihood of an arc flash occurring between the ionization section and the rotational shaft and/or frame.

An additional advantage of the current technology is that it allows for particle capture in existing ventilation systems without compromising the specifications of the existing system. The particle collection unit in the duct increases the air resistance in the system. As a result, the system's fan will require more energy to deliver the same airflow rate compared to when there was no collection unit. Under normal operating conditions, the fan does not need to operate at maximum capacity to exhaust the desired amount of air per unit of time. When the particle collection unit according to the invention is placed in the duct, slightly more power will be required under normal operating conditions to exhaust the desired amount of air per unit of time and capture particles. Since under normal conditions the fan is not working at maximum capacity, this slight increase of power is available without requiring a new fan. In emergency situations, such as a fire, maximum airflow may need to be either supplied or extracted from the space containing the fire in order to remove smoke and increase visibility. In those situations, capturing particles is not critical. By opening the particle collection unit, the air resistance caused by the particle collection unit becomes negligible, allowing the minimum airflow required by a directive to be maintained during a fire again without requiring a new fan.

The ability to rotate the one or more slat elements further makes it possible, depending on the desired application of the ducted ventilation system, to put the particle collection section in a closed status enabling the particle collection unit to filter the air flow through the ionisation members and particle collection member or in an open status enabling to minimize the air resistance through the ducted ventilation system. The open status further allows access for a service technician from an upstream side of the particle collection unit to a downstream side of the particle collection unit to perform maintenance on the ducted ventilation system downstream the particle collection unit or vice-versa, depending on whether service access is located upstream or downstream.

In an embodiment, the particle collection unit comprises at least two slat elements forming a slat structure with substantially parallel rotational axes. These features provide a simple construction to obtain a particle collection unit that can alternately be placed in an open and in a closed position.

In a further embodiment, each slat element is individually rotatable about its rotational axis. This feature allows the filter properties and the air resistance of the particle collection section to be changed in a number of steps.

In an embodiment, the rotational axis substantially coincides a central body axis of a particle collection member. This feature provides particle collection members in which the rotational force exerted on the particle collection member by an air flow is not dependent on the direction of air flow through the ducted ventilation system. The force of the air flow exerted on the slat element on both sides of the axis thus cancel each other out, requiring a less powerful actuator to rotate the unit.

In an embodiment, each particle collection member has a rectangular shape, wherein its rotational axis is along a length side of the rectangular shape. This feature is advantageous when there is very little space in a shaft, for example, between the filter and fire dampers. This reduces the amount of space required for the system and allows the fire dampers to be approached easily for maintenance.

In an embodiment, the ducted ventilation system further comprises an actuator system for rotating one or more slat elements between the first position and the second position, wherein in the event of an interruption of power supplied to the actuator system, the actuator moves the one or more slat elements into the second position. This allows the one or more particle collection members to be brought into the desired rotational position automatically and/or remotely. In a further embodiment, the actuator system comprises a corresponding actuator element for each of the one or more slat elements to rotate each slat elements individually. In a further embodiment, when in the event of an interruption of power supplied to an actuator element, the slat element corresponding to said actuator is moved into the second position. This feature is advantageous in combination with a fire protection system to provide a fail-safe system. If there is a power failure, the one or more particle collection members automatically rotate to the position with the lowest air resistance so that, in the event of a fire, smoke can be easily drawn through the system out of the building or smoke-free air blown into the building.

In a further embodiment, the ducted ventilation system comprises a control unit to control the actuator system in response to a volumetric flow rate signal indicative of the desired volumetric flow rate through the air duct. These features make it possible to add a filter function to an existing ventilation system, so that almost no additional adjustments, such as a more powerful fan, are required to meet the specification of the existing air duct system and particles can be removed from the air flow through the ventilation system in most circumstances.

In an embodiment, the control unit is configured to interrupt the power supplied to the actuator system. This provides a simple way to obtain a fail-safe system. In a further embodiment, the actuator system and the ionisation section are coupled to the control unit such that the control unit can simultaneously interrupt the power supplied to the actuator system and ionisation section. With these features, a maintenance technician can be assured that the ionization section is without voltage when the slats are open, helping to prevent electric shocks.

In an embodiment, power is only supplied to the ionisation section as soon as an angle difference between the current rotation angle of the slat members becomes less than a predetermined angle value. This feature further reduces the risk of an arc flash and electrocution (due to the high voltage of the ionisation section) for a maintenance technician. The closing of the slat elements is relatively slow compared to the opening process. As soon as a technician observes the slat members starting to rotate, he can still move to a safe position without being electrocuted. Power is supplied to the ionization members only when the slat members are almost closed.

In an embodiment, the ducted ventilation system comprises a valve section, wherein the particle collection unit is situated upstream the valve section. The one or more rotatable particle collection members allow for easy access via an air inlet opening to the valve section, e.g. fire damper section, for maintenance. Since the air is filtered before it passes through the valve section, less frequent maintenance will be required.

In an alternative embodiment, the ionisation section and particle collection section are coupled to form a filter valve for particles that in operation runs through said air duct, said filter valve comprising a series of aligned slats substantially in a particle collection plane, the slats having a longitudinal axis and which are rotatable about a slat rotational axis, wherein the slats have a closed slat position in which the slats together close off the air duct for particles, and an open slat position in which the slats allow particles to flow through the air duct downstream the particle collection section.

In an embodiment, the particle collection section comprises one or more collection elements taken from a group comprising: a fiber dust filter element, an actively charged electrostatic filter element, an electret filter element or an electrostatic precipitator element using charged conductive plates or sheets of any form, for instance flat plates, honeycomb, bent or wavy sheets. In principle any type of particle collection element may be used.

In a second aspect there is provided a particle collection unit (800) comprising an ionisation section and a particle collection section, wherein the particle collection section is configured for removing particles from air flowing through the particle collection unit. The ionisation section comprises one or more ionisation members and the particle collection section comprises corresponding one or more particle collection members. Each ionisation member is attached to a corresponding particle collection member to form a slat element that is rotatable about a rotational axis between a first position wherein air flowing through the duct mainly flows through the one or more combinations of an ionisation members and particle collection members and a second position wherein the air mainly flows along the combination of one or more ionization members and particle collection members.

In a third aspect there is provided method for a ducted ventilation system, comprising:
providing a particle collection unit in a duct of the ducted ventilation system, rotating the one or more particle collection members in a first position when the ducted ventilation system is in an operating status to remove particulate material from a flow of air through a duct; and, rotating at least one of the one or more particle collection members in a second position when the ducted ventilation system is in another operating status of the ducted ventilation system. These features make it possible for an existing air duct system to which a particle collection section is subsequently added to still meet the original specification in terms of maximum flow rate without having to use more powerful fans.

The terms “upstream” and “downstream” relate to an arrangement of items or features relative to a flow of air. Relative to a first position within a stream of air, e.g. a fire damper, a second position in the stream of air closer to the air inlet opening is “upstream”, and a third position within stream of air further away from the air inlet opening is “downstream”.

The term “substantially” herein, such as in “substantially parallel” or in “substantially coincides”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 75% or higher, such as 90% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. For instance, if an antenna is functionally coupled or functionally connected to a communication device, received electromagnetic signals that are receives by the antenna can be used by the communication device. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

### BRIEF DESCRIPTION OF THE DRAWINGS

These and other aspects, properties and advantages will be explained hereinafter based on the following description with reference to the drawings, wherein like reference numerals denote like or comparable parts, and in which:

FIG. 1 schematically shows a first embodiment of a part of a ducted ventilation system with a particle collection section in a first position;

FIG. 2 schematically shows the first embodiment with the particle collection section in a second position;

FIG. 3 schematically shows the first embodiment with the particle collection section in the second position with partially removable air inlet grating;

FIG. 4 schematically shows a second embodiment of a part of a ducted ventilation system with a particle collection section in the first position;

FIG. 5 schematically shows the second embodiment with the particle collection section in the second position;

FIG. 6 schematically shows a third embodiment of a part of a ducted ventilation system with a particle collection section in the first position;

FIG. 7 schematically shows the third embodiment with the particle collection section in the second position;

FIG. 8 shows a perspective view of a first assembly comprising an ionisation section and particle collection section in the first position;

FIG. 9 shows a perspective view of the first assembly in the second position; and,

FIG. 10 shows a front view of the first assembly in the second position.

### DESCRIPTION OF THE INVENTION

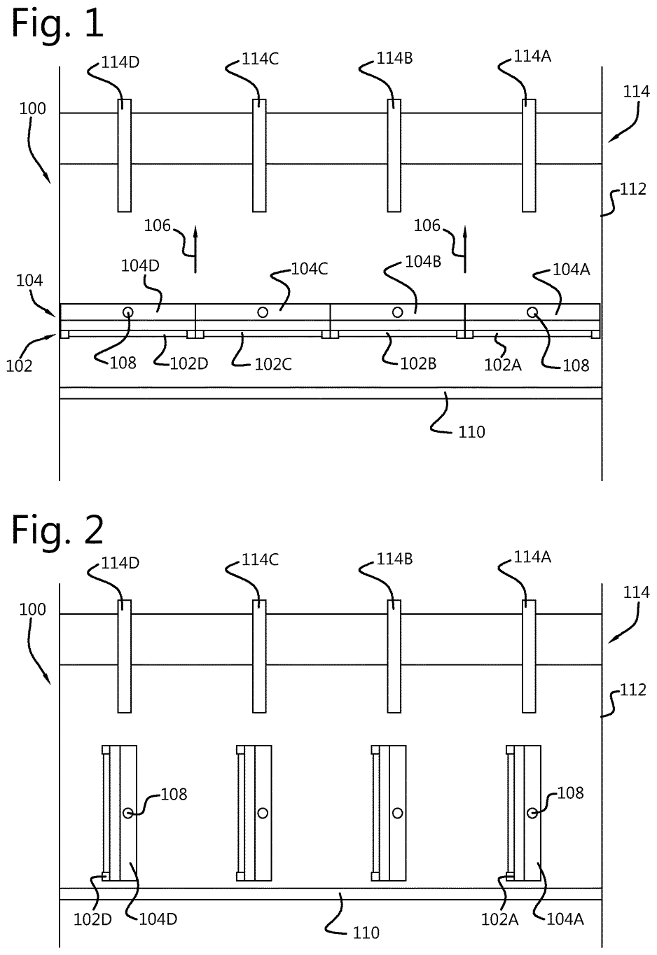

FIG. 1-2 schematically show a first embodiment of a part of a ducted ventilation system 100. A ducted ventilation system 100 according to the subject technology comprises one or more coupled air ducts 112, an ionisation section 102 and a particle collection section 104, one or more air flow generators (not shown), e.g. fans, one or more air inlet openings, one or more air outlet openings, and optionally a fire damper section 114. For safety reasons, the air openings are provided with safety gratings 110. The air ducts system can also be provided with many other devices and systems for actuating air in the air ducts, heat exchangers, valve, doors, filters or rain grating. The term air duct 112 also includes air channel or air shaft. The combination of ionisation section 102 and the particle collection section 104 forms a particle collection unit. The current air ducts in which the air duct particle collection system can be applied have a cross sectional area of at least 0.36 m² , in particular at least 1 m² . More in particular, the cross sectional area is at least 4 m² . Usually, the air duct has a cross sectional area smaller than 25 m². Usually in most applications, the cross sectional area is smaller than 10 m².

The ionisation section comprises wires, needles, brushes or barbed-wire like structures, metal strips with one or more edges forming a row of corona points or an ionising source, e.g. UV light, to charge particulate material passing through the ionisation section.

In an air flow through a duct, the ionisation section 102 is located upstream the particle collection section 104. The particle collection section 104 is configured for removing particulate material from an airflow through the ducted ventilation system. The ionisation section comprises one or more ionisation members 102A, 102B, 104C 104D. The particle collection section comprises one or more particle collection members 104A, 104B, 104C, 104D. Each ionisation member is attached to a corresponding particle collection to form a slat element that is rotatable about a rotational axis 108 between a first position, shown in FIG. 1 and a second position, shown in FIG. 2. In the first position, air flows mainly through the ionisation members and the particle collection members. In the second position the air mainly flows along the ionisation members and particle collection members. The slat elements are aligned in a plane, have a longitudinal axis and are rotatable about a slat rotation axis. The slats together form a filter valve for particles that in operation flow through the air duct. The slats have a closed slat position in which the slats together close off the air duct for particles so that the particles are collected in the particle collection members, and an open slat position in which the slats allow particles to flow through the air duct downstream the particle collection section.

Functionally when the ducted ventilation system filters at least 75% of all pollutants from an air flow sucked from a building space, the ionisation section 102 is located in the ducted ventilation system upstream to the particle collection section 104. The direction of the air flow through the air duct 112 is indicated by reference 106. The ionisation section will charge the air particulates and the particle collection section captures the charged particles. The particle collection members 104A, 104B, 104C and 104D can be any type of assembly or material suitable to attract charged particles. Types of assembly or material are not limited to: a fibre dust filter element, an actively charged electrostatic filter element, an electret filter element and an electrostatic precipitator element using charged conductive plates or sheets of any form, for instance flat plates, honeycomb, bent or wavy sheets, etc.

The main feature of electret filter elements is their ability to remove particulate matter from polluted air by strong electrostatic forces generated by the static electret fibres from which they are made. Electret filter elements are not actively charged filters.

In the first embodiment, the particle collection members form a slat structure with substantially parallel rotational axes 108. Each particle collection member may be individually rotatable about its rotational axis 108. The rotational axis 108 of each particle collection member substantially coincides a central body axis of a particle collection member. Each particle collection member has a rectangular shape, wherein its rotational axis is along a length side of the rectangular shape. To each of the particle collection members 104A, 104B, 104C, 104D, an ionisation part 102A, 102B, 102C, 102D of said ionisation section 102 is mounted to rotate together with the particle collection member about the rotational axis 108.

The ducted ventilation system 100 further comprises a fire damper section or valve section 114. The fire damper/valve section comprises four fire damper/valve units 114A, 114B, 114C, 114D. In FIG. 1, the fire dampers or valves are in the open state. In this state, the air stream flows freely through the fire damper section or valve section. To prevent unauthorised excess into the ducted ventilation system, a safety grating or rain grating 110 is provided in the duct.

The slat structure functions as a venetian blind wherein the slats can be in open position and closed position. FIG. 1 schematically shows a first position, also named closed position or filter position of the slat structure. In this position substantially all of the air flowing through the ducted ventilation system flows through the particle collection members. In the first position, the particle collection section captures at least 75% of the particulate material from the air stream flowing through the duct. In the first position, the particle collection section increases the air resistance of the ducted ventilation system. Depending on the air flow, the pressure drop over the particle collection section can be 10 Pa.

FIG. 2 schematically shows the first embodiment with the particle collection section in a second position. In this position, the particle collection members 104A-D are rotate a quarter turn with respect to the first position. The second position is a maximal volumetric flow rate position or a maintenance position. When the air duct particle collection system is built in an existing air duct system, the capacity of the air flow generation device may be insufficient to generate a volumetric flow rate that is at least a specified minimal calamities volumetric flow rate when the particle collection members are in the first position. Calamities include, but are not limited to, fire and/or exceeding a predefined CO level or other hazardous gas level in a building space. By rotating the particle collection member from the first to the second position, the air resistance of the air duct particle collection system decreases significantly, as a result the capacity of the air flow generation system will be sufficient to generate a volumetric flow rate that exceeds the specified minimal calamities volumetric flow rate. Furthermore, the second position allows access to a service technician to perform regular preventive maintenance. By removing the safety gratings 110, the service technician can reach the fire dampers by passing the created openings between two particle collection members.

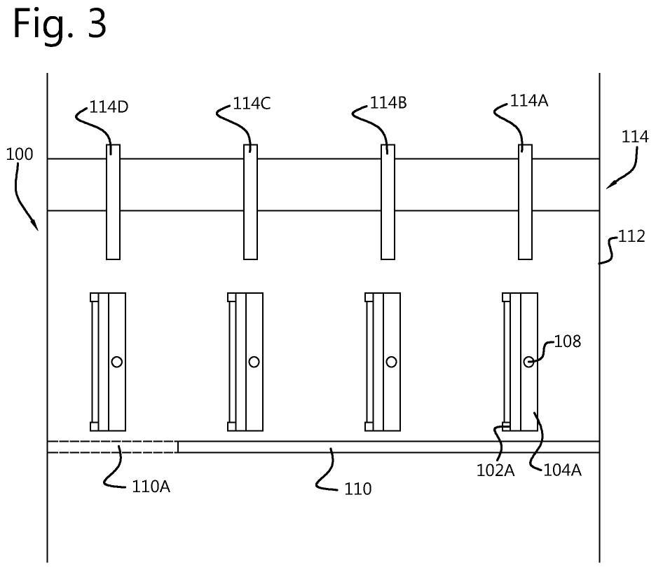

FIG. 3 schematically shows the first embodiment with the particle collection section in the second position with partially removable air inlet grating 110A. In this embodiment, when the particle collection section is in the second position, there is a distance between the particle collection members and the fire dampers of at least 50 cm, which is sufficient to reach each of the fire dampers for maintenance.

In an embodiment of the ionisation section, the ionisation section comprises a corona electrode structure formed by wires, needles, brushes or barbed-wire like structures and a non-corona electrode structure formed by a grid of wires, or strips with one or more edges forming a row of corona points. If the ionisation section is attached to the particle collection members, the particle collection members may be in direct contact with the non-corona electrode structure.

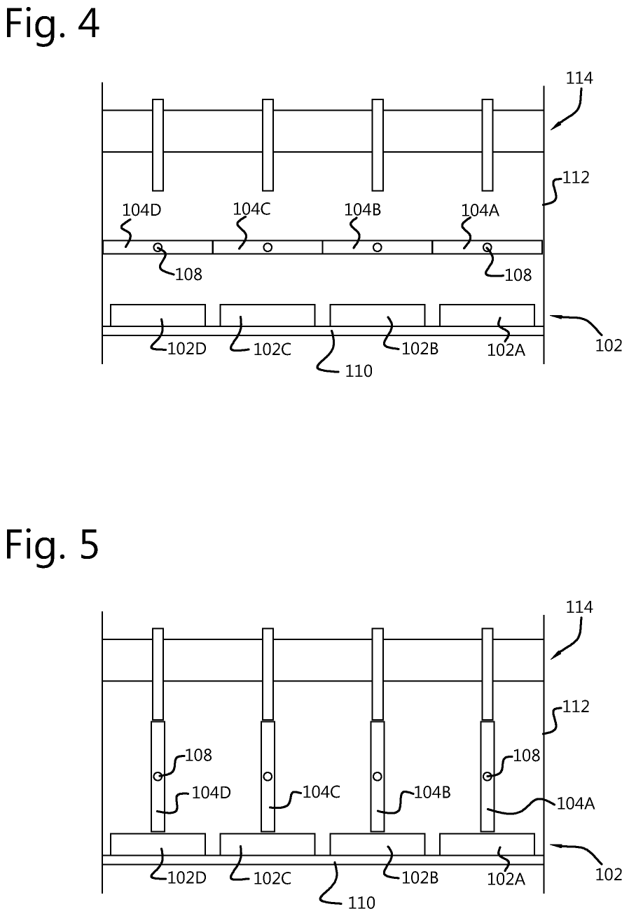

FIG. 4 schematically shows a second embodiment of a part of a ducted ventilation system which do not fall within the scope of the present claims. In FIG. 4 the particle collection section in the first position. In this embodiment, the ionisation section 102 is attached to the gratings 110. FIG. 5 schematically shows the second embodiment with the particle collection section in the second position. By removing all the gratings and ionisation section, a service technician is able to service all the components installed in the duct and accessible via the inlet, for instance, the fire damper as shown in FIG. 5. After servicing the fire damper, the ionisation section and gratings need to be reinstalled. This takes substantially more time than just removing and reinstalling the whole grating or a part of the grating. If there is sufficient distance available between the safety gratings and the fire dampers, it may be possible to remove only a portion of the grating and ionisation section to provide access to the fire dampers. However, this requires more space or larger distance between grating and fire dampers than in the first embodiment. As a result, the second embodiment will be less frequently utilized in existing ventilation systems to upgrade the particle removal characteristics. As the air resistance of the ionisation section is substantially lower than the air resistance of the particle collection section, only the particle collection members have to be positioned in a plane perpendicular to the direction of the air flow, which is the second position, if the capacity of the air flow generator system is not sufficient to exceed the minimal desired volumetric air flow in case of calamities. In this embodiment, the ionisation section 102 and particle collection section are spaced from another.

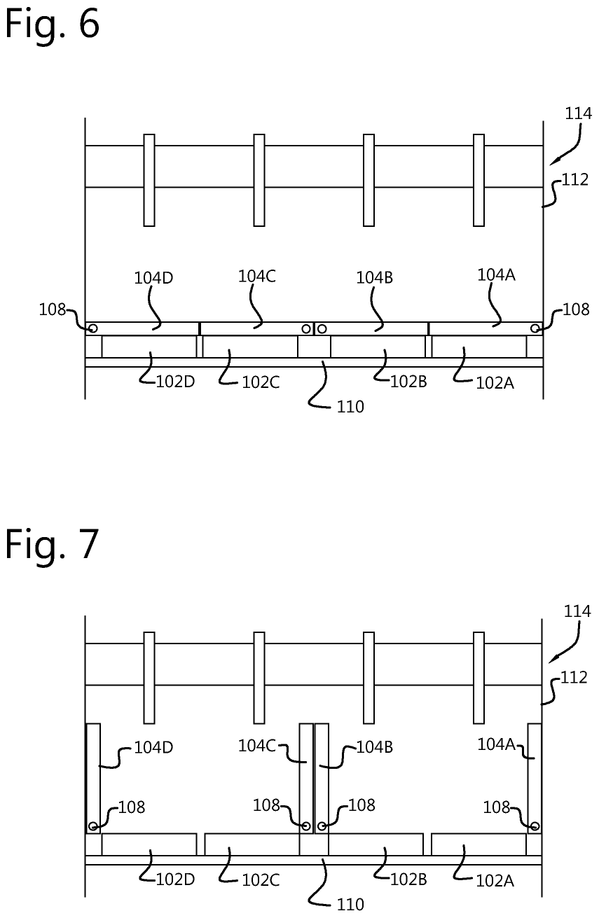

FIG. 6 schematically shows a third embodiment of a part of a ducted ventilation system which do not fall within the scope of the present claims. In FIG. 6 the particle collection section in the first position and FIG. 7 schematically shows the third embodiment with the particle collection section in the second position. This embodiment differs from the previous embodiments in that the rotational axis 108 is along a side of the particle collection members 104A-D. This has the advantage that a larger opening is created between two neighbouring particle collection members for a service technician to perform maintenance. In the third embodiment the ionisation section is attached to the grating 110. However, the third embodiment has similar disadvantages to the second embodiment compared to the first embodiment.

It should be noted that an embodiment in which the particle collection member forms a slat element comprising a particle collection member to which an ionisation member is attached, with a rotational axis located along one side of the particle collection member, provides similar advantages as the first embodiment.

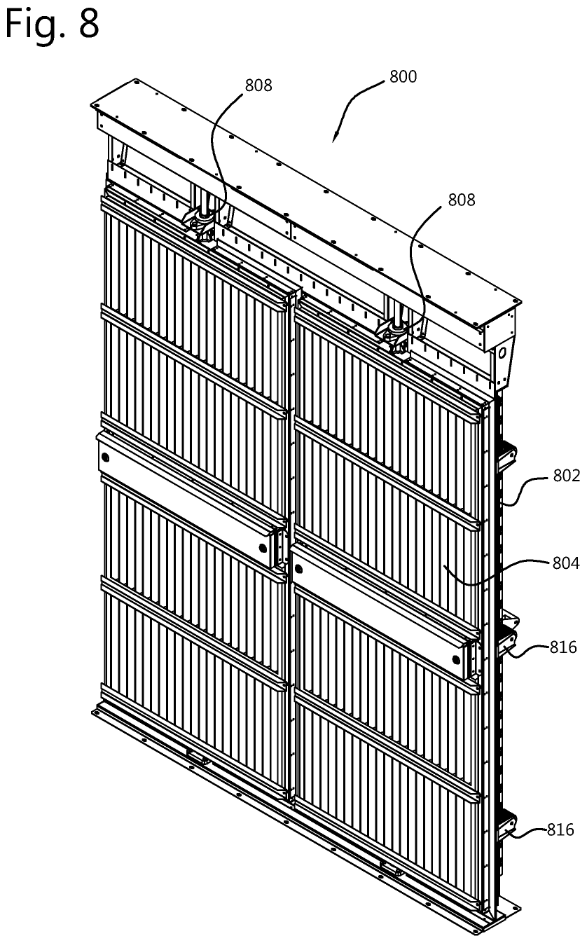

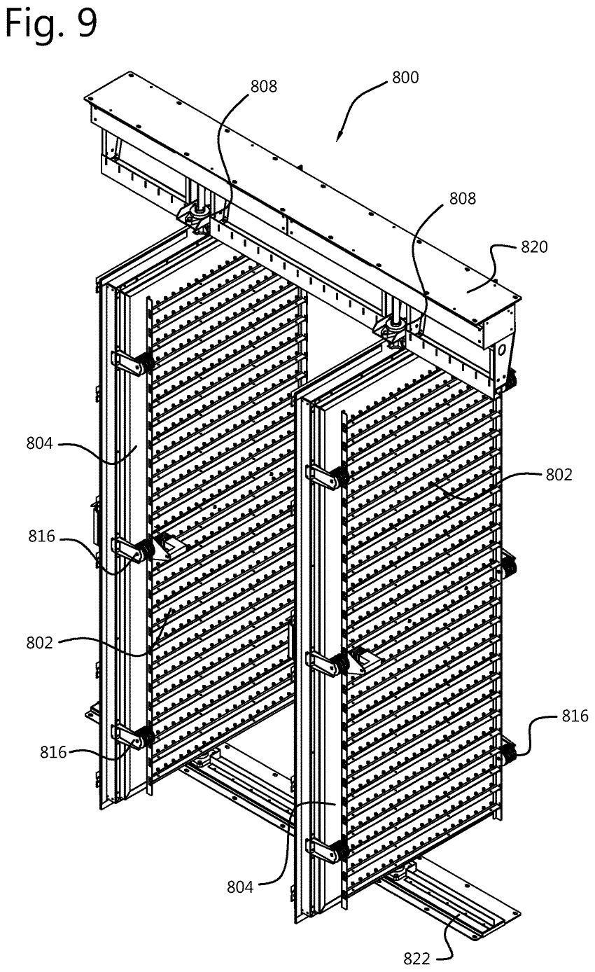

FIGS. 8 and 9 show a perspective view of a first assembly 800 forming a particle collection unit 800 comprising an ionisation section and particle collection section. The assembly comprise two particle collection members 804 and ionisation elements 802 attached to each other by spacers 816. The spacers set the corona electrode of the ionisation elements at distance from the particle collection member 804. To keep the slat element as thin as possible, the non-corona electrodes of the ionisation members are positioned against surfaces of corresponding particle collection members. The particle collection member 804 comprises a rotational bar 808. The rotational bar 808 couples the particle collection member at a bottom side to a bottom frame part 822 and at a top side to a top frame part 820. The top frame part accommodates an actuator system configured to rotate each of the particle collection members about its rotational axis. The actuator system can comprise a corresponding actuator element for each of the particle collection members to rotate each particle collection member individually. In another embodiment of the actuator system, the system is configured to rotate al particle collection members simultaneously. For safety reason, when an actuator element is not powered, the corresponding particle collection member is forced in the second position.

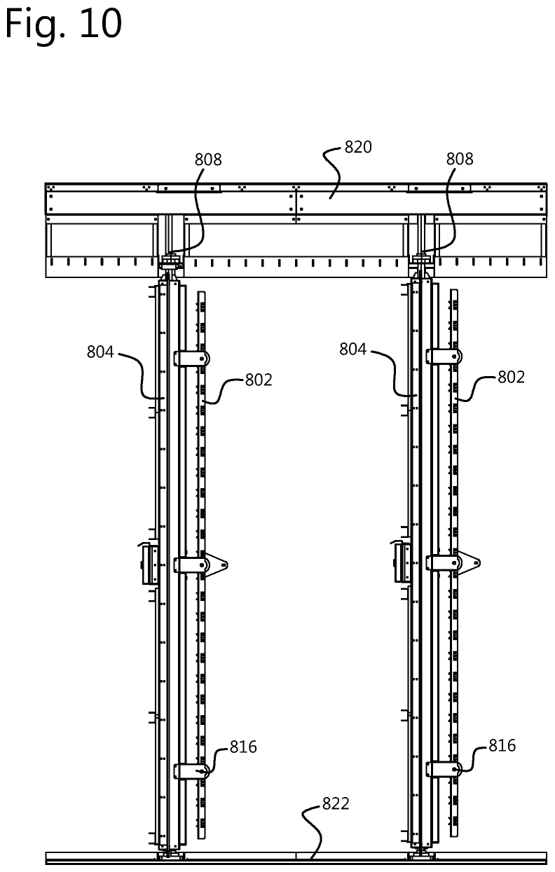

The actuators can be driven by compressed air, oil pressure, air pressure, an electromotor. In an embodiment, the particle collection section is kept in the first position by the actuator or motor, and moves to the second position if the actuator stalls. FIG. 10 shows a front view of the first assembly in the second position. For a person skilled in the art it will be clear that the air resistance of the first assembly will be very low.

In the embodiments described above, the particle collection members have a vertical rotational axis. In a vertical shaft, the rotational axis may be horizontal. When the particle collection members are in the first position, they form a horizontally positioned filter.

Normally, an existing air duct system comprises a control unit to control the air flow generators, valves and fire dampers independence of sensor signals or human input. For example, the volumetric air rate in the ducted ventilation system depends on the measured pollution of air in the building. Any suitable sensor that matches the use of the building/facility, for instance PM sensor, temperature sensors, CO sensors and/or any other gas sensor can be used to generate an input signal for the control unit to control the ducted ventilation system. When a sensor detects a fire/calamity in a room of the building, certain fire dampers/valves will be closed, and the air generator unit will be controlled to extract contaminated air, such as smoke out or CO, from a space or supply fresh air into said space. When a particle collection unit according to the subject disclosure is added to an existing air duct system, the control unit has to be adapted to also control in response to sensor signals the actuators for moving the slat elements of the particle collection unit in the desired position. The control unit will then need to be adapted to control the actuator system in response to at least one signal from a sensor taken from a group comprising: particle sensor, CO sensor, CO2 sensor, temperature sensor, odor sensor, NOx sensor, O2-Sensor, and volumetric flow rate sensor.

The control unit performs a method for a ducted ventilation system, comprising:
rotating the one or more particle collection members in a first position when the ducted ventilation system is in an operating status to remove particulate material from a flow of air through a duct; and,
rotating at least one of the one or more particle collection members in a second position when the ducted ventilation system is in another operating status of the ducted ventilation system.

When actuator elements are used that forces continuously the collection members into the first position when the actuators are powered and the collection members into the second position when the actuators are not powered, this has the advantage that a simple on/off control signal may be used to control a particle collection assembly. In an embodiment of an actuator element, an actuator motor moves a collection member to the first position at the same time as tensioning a return spring structure. The collection member is turned back to the second position by spring force when the supply voltage is interrupted. The control signal only needs to switch on the mains voltage of the particle collection assembly to supply power to both the ionisation section and the actuators of the particle collection section, so that the particle collection assembly will function as particle filter. Then, the ionisation section will charge the particulate material in the air flow and the actuators will force the particle collection members into the first position, so that the particle collection section will collect the charged particulate material in the air flow. When the control signal switches off the power supplied to both the ionisation section and actuators, the ionisation section will become idle and the particle collection section will go in the second position. Now the particle collection assembly is in a state with low air resistance and also in a state for maintenance, as there will be no high voltage present in the ionisation section.

In an embodiment, power is supplied to the ionisation section as soon as an angle difference between the current rotation angle of the slat members becomes less than a predetermined angle value. In an embodiment, the actuators are equipped with switches with settings that allow a predetermined rotation angle to be indicated by opening or closing a switch contact and supplying power to the corona electrode of an ionisation section in response. Other angle sensors can be used to detect if a slat element is in the closed position, generating a signal indicating that power can be supplied to the ionization section.

From the description above you can learn that the particle collection section forms a filter valve for particles that in operation runs through said air duct. Said filter valve comprises a series of aligned slats substantially in a particle collection plane. The slats have a longitudinal axis and are rotatable about a slat rotational axis. The slats have a closed slat position in which the slats together close off the air duct for particles, and an open slat position in which the slats allow particles to flow through the air duct downstream the particle collection section.

The devices, apparatus and systems herein are amongst others described during operation. As will be clear to the person skilled in the art, the invention is not limited to methods of operation or devices in operation.

In the embodiments described above a particle collection section is used to reduce the amount of particulate material in the flow of air. The particle collection section may also be combined with material suitable for capturing gaseous pollutants, such as NOx or VOC's from the air stream through the ducted ventilation system. Material that may be used is not limited to active carbon, an active media comprising a metal-organic framework (MOF) containing an amine functional group capable of reacting with the pollutant, or a coating capable of reacting with the pollutant. Filters suitable to capture gaseous pollutants have normally a higher air resistance than filters collecting particulate material. The gaseous removal materials can also be part of the particle collection section, for instance when the particle collection material is coated with for example TiO₂ or when adsorption materials is integrated into the collector materials, for instance activated carbon in filters.

In the embodiments described above an ionisation section is present. An ionisation section can significantly improve particle capture. The ionisation section charges the particles in the air flow and thus increases the particle capture performance of an actively charged electrostatic filter element, an electret filter element or an electrostatic precipitator element using charged conductive plates. At the same time, the use of an ionisation section allows the pressure drop over the particle collection section to be reduced. The improved particle capture by ionisation allows the performance of lower cost lower grade filters with lower pressure drop to be improved while the particle capture performance remains the same or even increases compared to a system without an ionisation section but with a particle collection section with higher grade filters that have a higher pressure drop.

It should be note that the particle collection unit 800 according to the subject technology can also be applied as filter unit in industrial installations. The particle collection unit with rotating slat members allows for maintenance of the slat members on both sides and also facilitates the maintenance of components that are installed upstream and/or downstream of the unit within the duct in which the unit is positioned. This is not possible when the slat members are not rotatable. In that case, at least a portion of the filter unit would need to be removed to maintain another component installed in the duct.

It should further be noted that the corona electrode of the ionisation section can be formed by wires, needles, brushes or barbed-wire like structures and a non-corona electrode can be formed by a grid of wires, or strips with one or more edges forming a row of corona points.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device or apparatus claims enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

1. A ducted ventilation system comprising a duct provided with a particle collection unit comprising an ionisation section and a particle collection section located downstream the ionisation section, wherein the particle collection section is configured for removing particles from air flowing through the duct,
the ionisation section comprises one or more ionisation members and the particle collection section comprises corresponding one or more particle collection members, wherein each ionisation member is attached to a corresponding particle collection member to form a slat element that is rotatable about a rotational axis between a first position wherein air flowing through the duct mainly flows through the one or more ionisation members and one or more particle collection members and a second position wherein the air mainly flows along the one or more ionisation members and particle collection members.

2. The ducted ventilation system of claim 1, wherein the particle collection unit comprises at least two slat elements forming a slat structure with substantially parallel rotational axes.

3. The ventilation system according to claim 2, wherein each slat element is individually rotatable about its rotational axis.

4. The ducted ventilation system according to claim 1, wherein the rotational axis substantially coincides a central body axis of a particle collection member.

5. The ducted ventilation system according to claim 1, wherein each particle collection member has a rectangular shape, wherein its rotational axis is along a length side of the rectangular shape.

6. ventilation system according to claim 1, comprising an actuator system to move the one or more slat elements between the first position and the second position, wherein in the event of an interruption of power supplied the actuator system; the actuator system moves the one or more slat elements into the second position.

7. The ducted ventilation system according to claim 6, wherein the actuator system comprises a corresponding actuator element for each of the one or more slat elements to rotate each slat element individually.

8. The ducted ventilation system according to claim 7, wherein in the event of an interruption of power supplied to an actuator element, the slat element corresponding to said actuator element is moved into the second position.

9. The ducted ventilation system according to claim 6, further comprising a control unit to control the actuator system in response to at least one signal from a sensor taken from a group comprising: particle sensor, CO sensor, CO₂ sensor, temperature sensor, odor sensor, NOx sensor, O2-Sensor, and volumetric flow rate sensor.

10. The ducted ventilation system according to claim 6, further comprising a control unit configured to interrupt the power supplied to the actuator system.

11. The ducted ventilation system according to claim 6, wherein the actuator system and the ionisation section are coupled to the control unit such that the control unit can simultaneously interrupt the power supplied to the actuator system and ionisation section.

12. The ducted ventilation system according to claim 6, wherein power is supplied to the ionisation section as soon as an angle difference between the current rotation angle of the slat members becomes less than a predetermined angle value.

13. The ducted ventilation system according to claim 1, further comprising a valve section, wherein the particle collection unit is upstream the valve section.

14. The ducted ventilation system according to claim 1, wherein the particle collection section and ionization section are coupled to form a filter valve for particles that in operation runs through said air duct, said filter valve comprising a series of aligned slats substantially in a particle collection plane, the slats having a longitudinal axis and which are rotatable about a slat rotational axis, wherein the slats have a closed slat position in which the slats together close off the air duct for particles, and an open slat position in which the slats allow particles to flow through the air duct downstream the particle collection section.

15. The ducted ventilation system according to claim 1, wherein the particle collection section comprises one or more particle collection elements taken from a group comprising: a fiber dust filter element, an actively charged electrostatic filter element, an electret filter element or an electrostatic precipitator element using charged conductive plates or sheets of any form, for instance flat plates, honeycomb, bent or wavy sheets.

16. A particle collection unit comprising an ionisation section and a particle collection section, wherein the particle collection section is configured for removing particles from air flowing through the particle collection unit, wherein
the ionisation section comprises one or more ionisation members and the particle collection section comprises corresponding one or more particle collection members, wherein each ionisation member is attached to a corresponding particle collection member to form a slat element that is rotatable about a rotational axis between a first position wherein air flowing through the duct mainly flows through the one or more ionisation members and one or more particle collection members and a second position wherein the air mainly flows along the one or more ionization members and particle collection members.

17. A method for a ducted ventilation system of a building, comprising:
providing a particle collection unit according to claim 15 in a duct of the ducted ventilation system,
rotating the one or more particle collection members in a first position when the ducted ventilation system is in an operating status to remove particulate material from a flow of air through a duct; and,
rotating at least one of the one or more particle collection members in a second position when the ducted ventilation system is in another operating status.
